(19) United States
(12) Patent Application Publication
(10) Pub. No.: US 2022/0306151 A1
(43) Pub. Date: Sep. 29, 2022

(54) DRIVING ASSISTANCE APPARATUS, DRIVING ASSISTANCE SYSTEM, AND DRIVING ASSISTANCE METHOD

(71) Applicant: Mitsubishi Electric Corporation, Tokyo (JP)

(72) Inventors: Shinsaku FUKUTAKA, Tokyo (JP); Tsuyoshi SEMPUKU, Tokyo (JP); Akiko IMAISHI, Tokyo (JP); Misato YUASA, Tokyo (JP); Munetaka NISHIHIRA, Tokyo (JP)

(73) Assignee: Mitsubishi Electric Corporation, Tokyo (JP)

(21) Appl. No.: 17/567,240

(22) PCT Filed: Aug. 1, 2019
(86) PCT No.: PCT/JP2019/030265

§ 371 Date: Jan. 3, 2022

(51) Int. Cl. B60W 60/00; B60W 50/14

(52) U.S. Cl. CPC B60W 60/005; B60W 50/14; B60W 2520/06; B60W 2520/10; B60W 2420/42

(57) ABSTRACT

A driving assistance apparatus includes: a determination processing unit to determine whether or not a vehicle is present around a target vehicle on the basis of detection information around the target vehicle; and a notification processing unit to notify information to a driver of the target vehicle, in which the notification processing unit notifies reference information of manual driving in a case where the determination processing unit determines that there is no vehicle ahead of the target vehicle.

### CROSS-REFERENCE TO RELATED APPLICATION

This application is a continuation of PCT filing PCT/JP2019/030265, filed Aug. 1, 2019, the entire contents of which are incorporated herein by reference.

### TECHNICAL FIELD

The present invention relates to a driving assistance apparatus, a driving assistance system, and a driving assistance method for assisting switching from autonomous driving to manual driving.

### BACKGROUND ART

Conventionally, in automobiles having an autonomous driving function, technology for assisting smooth switching from autonomous driving to manual driving (transfer of driving authority from a vehicle to a driver) has been proposed. For example, Patent Literature 1 describes an apparatus that assists recognition, determination, and operation of a driver upon switching from autonomous driving to manual driving. Upon switching from autonomous driving to manual driving, this apparatus enhances driving assistance by calling attention to an obstacle having a lower risk than normally noted among obstacles around the vehicle. Note that obstacles around the vehicle include, for example, vehicles, pedestrians, bicycles, and motorcycles.

### CITATION LIST

### Patent Literature

Patent Literature 1: WO 2017/060978

### SUMMARY OF INVENTION

### Technical Problem

Meanwhile, according to an experimental analysis conducted by the inventor of the present invention on the drivers' driving operation at the timing when autonomous driving is switched to manual driving in a vehicle targeted for manual driving (hereinafter referred to as the target vehicle), it has been found that a driver tends to make an error in the driving operation when no vehicle is present ahead of the target vehicle as compared to a situation in which there is a vehicle traveling ahead of the target vehicle. It is conceivable that there is a tendency for drivers, who are driving the target vehicle, to refer to another vehicle traveling ahead. Meanwhile, since the apparatus described in Patent Literature 1 calls for attention to an object present around the target vehicle upon switching from autonomous driving to manual driving, it is not possible to appropriately assist manual driving switched from autonomous driving in a case where there is no vehicle ahead of the target vehicle.

The present invention solves the above problems, and an object of the present invention is to provide a driving assistance apparatus, a driving assistance system, and a driving assistance method capable of assisting manual driving switched from autonomous driving when there is no vehicle ahead of a target vehicle.

### Solution to Problem

A driving assistance apparatus according to the present invention includes processing circuitry configured to determine whether or not a vehicle is present around a target vehicle on the basis of detection information around the target vehicle and notify information to a driver of the target vehicle. When automatic driving is switched to manual driving in the target vehicle and before and after the switching, and it is determined that there is no vehicle ahead of the target vehicle, the processing circuitry notifies reference information of manual driving.

### ADVANTAGEOUS EFFECTS OF INVENTION

According to the present invention, in a case where there is no vehicle ahead of a target vehicle, reference information for manual driving is notified. This makes it possible to assist manual driving switched from autonomous driving in a case where there is no vehicle ahead of the target vehicle.

### BRIEF DESCRIPTION OF DRAWINGS

FIG. 1 is a block diagram illustrating the configuration of a driving assistance apparatus according to a first embodiment.

FIG. 2 is a flowchart illustrating a driving assistance method according to the first embodiment.

FIG. 3A is a diagram illustrating a case where a vehicle is present ahead of a target vehicle, and FIG. 3B is a diagram illustrating a case where no vehicle is present ahead of the target vehicle.

FIG. 4 is a diagram illustrating display example 1 of image information simulating a vehicle traveling ahead of the target vehicle.

FIG. 5 is a diagram illustrating display example 2 of image information simulating a vehicle traveling ahead of the target vehicle.

FIG. 6A is a block diagram illustrating a hardware configuration for implementing the functions of the driving assistance apparatus according to the first embodiment, and FIG. 6B is a block diagram illustrating a hardware configuration for executing software for implementing the functions of the driving assistance apparatus according to the first embodiment.

FIG. 7 is a block diagram illustrating the configuration of a driving assistance apparatus according to a second embodiment.

FIG. 8 is a flowchart illustrating a driving assistance method according to the second embodiment.

FIG. 9A is a diagram illustrating modification 1 of display of image information simulating a vehicle traveling ahead of a target vehicle, and FIG. 9B is a diagram illustrating modification 2 of display of image information simulating a vehicle traveling ahead of the target vehicle.

FIG. 10 is a block diagram illustrating the configuration of a driving assistance apparatus according to a third embodiment.

FIG. 11 is a flowchart illustrating a driving assistance method according to the third embodiment.

FIG. 12 is a block diagram illustrating the configuration of a driving assistance apparatus according to a fourth embodiment.

FIG. 13 is a flowchart illustrating a driving assistance method according to the fourth embodiment.

FIG. 14 is a diagram illustrating a modification of display of image information simulating a vehicle traveling ahead of a target vehicle in the fourth embodiment.

FIG. 15 is a block diagram illustrating the configuration of a driving assistance apparatus according to a fifth embodiment.

FIG. 16 is a flowchart illustrating a driving assistance method according to the fifth embodiment.

FIG. 17 is a block diagram illustrating the configuration of a driving assistance apparatus according to a sixth embodiment.

FIG. 18 is a flowchart illustrating a driving assistance method according to the sixth embodiment.

FIG. 19 is a flowchart illustrating another mode of the driving assistance method according to the sixth embodiment.

FIG. 20A is a diagram illustrating a target vehicle and a following vehicle, and FIG. 20B is a diagram illustrating a case where traveling of the target vehicle is controlled so that the following vehicle comes ahead.

FIG. 21 is a block diagram illustrating a configuration example of a driving assistance system according to a seventh embodiment.

### DESCRIPTION OF EMBODIMENTS

### First Embodiment

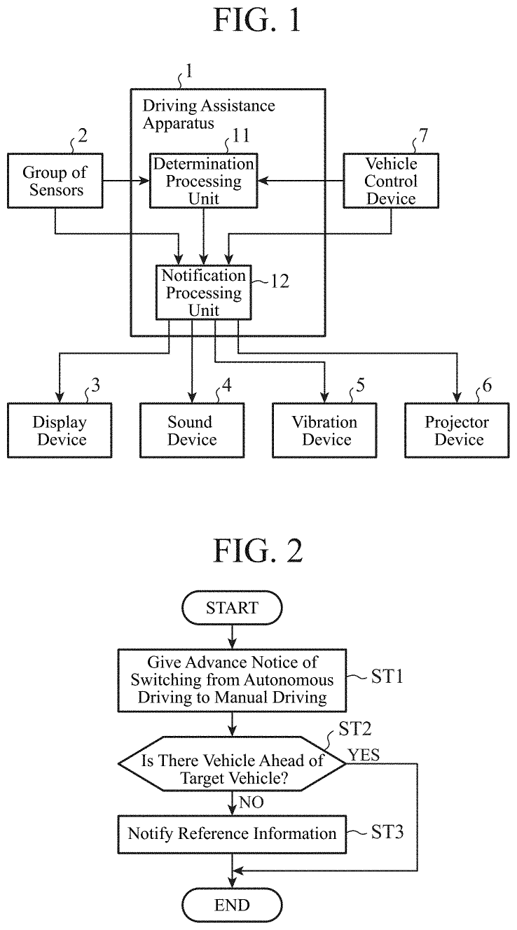

FIG. 1 is a block diagram illustrating the configuration of a driving assistance apparatus 1 according to a first embodiment. The driving assistance apparatus 1 is included in a target vehicle and assists switching from autonomous driving to manual driving (transfer of driving authority from the vehicle side to the driver). The target vehicle is mounted with a group of sensors 2, a display device 3, a sound device 4, a vibration device 5, a projector device 6, and a vehicle control device 7. The display device 3, the sound device 4, the vibration device 5, and the projector device 6 are output devices of the target vehicle.

In a case where there is no vehicle ahead of the target vehicle at the time of switching from autonomous driving to manual driving, the driving assistance apparatus 1 notifies reference information of manual driving using at least one of the display device 3, the sound device 4, and the projector device 6. As a result, the driver of the target vehicle can drive in accordance with the reference information. At this time, the driving assistance apparatus 1 can cause the driver to feel whether or not driving in accordance with the reference information is executed by transmitting the vibration output from the vibration device 5 to the driver. For example, when the driver makes the speed of the target vehicle to be faster than a speed recommended by the reference information, it is possible to call attention to the driver with the vibration device 5 transmitting vibration to the driver.

The group of sensors 2 includes, for example, a vehicle speed sensor, a steering angle sensor, an accelerator sensor, a brake sensor, a shift sensor, a blinker sensor, a hazard sensor, a wiper sensor, a light sensor, an in-vehicle camera, an acceleration sensor, an angular velocity sensor, a GPS device, a navigation system, an illuminance sensor, an exterior camera, and an exterior sensor mounted on the target vehicle.

The vehicle speed sensor detects the speed of the target vehicle and outputs an electric signal (vehicle speed pulse) corresponding to the wheel speed. The steering angle sensor detects the steering angle of the target vehicle and outputs an electric signal corresponding to the steering angle. The accelerator sensor detects an opening degree of an accelerator, that is, an operation amount of the accelerator pedal and outputs operation amount information of the accelerator pedal. The brake sensor detects the operation amount of the brake pedal and outputs operation amount information of the brake pedal. The shift sensor detects the state of the shift lever and outputs operation information of the shift lever.

The blinker sensor detects an operation of a blinker (direction indicator) of the target vehicle and outputs information indicating a direction indicated by the blinker. The hazard sensor detects an operation of the hazard switch of the target vehicle and outputs operation information of the hazard switch. The wiper sensor detects an operation of the wiper of the target vehicle and outputs operation information of the wiper. The light sensor detects an operation of a light lever that operates lights of the target vehicle and outputs operation information of the light lever.

The in-vehicle camera is provided facing the driver's seat of the vehicle and captures an image of the driver seated at the driver's seat. The in-vehicle camera captures an image of the face or the upper body of the driver and outputs the captured image information. The acceleration sensor detects the acceleration of the target vehicle, and is, for example, a three-axis acceleration sensor. The angular velocity sensor detects the angular velocity of the target vehicle. The angular velocity is information for calculating the turning speed of the target vehicle.

The GPS device receives a radio wave transmitted from GPS satellites using the global positioning system and detects the position of the target vehicle. The navigation system searches for a route for guiding the target vehicle to a destination on the basis of the position information of the target vehicle detected by the GPS device and map information. The navigation system further has a communication function and acquires congestion information or road closure information from an external source. The illuminance sensor detects the illuminance around the target vehicle.

The exterior camera photographs the surroundings of the target vehicle. The exterior cameras are each provided, for example, on the front, the rear, the right, and the left sides of the target vehicle and output each captured image to the driving assistance apparatus 1. The exterior sensor detects an object around the target vehicle and is, for example, at least one of an ultrasonic sensor, a radar sensor, a millimeter wave radar sensor, or an infrared laser sensor.

The display device 3 is provided inside the passenger compartment of the target vehicle and displays information. The display device 3 is, for example, a head-up display (hereinafter referred to as HUD). The HUD is a display device that projects information onto a projection member such as a windshield or a combiner of the target vehicle. The display device 3 can change the position on the screen for displaying information (position on the projection plane), the color, the size, the timing, the luminance, and time for displaying the information, and the shape of an image including indicators and the like under control by the driving assistance apparatus 1.

The sound device 4 is provided inside the passenger compartment of the target vehicle and outputs sound information. For example, the sound device 4 outputs sound information using an in-vehicle speaker. Alternatively, the sound device 4 may be a mobile terminal having a speaker such as a smartphone or a tablet device. The sound device 4 can change the tone, the pitch, the tempo, the rhythm, and the volume of the sound information to be output under control by the driving assistance apparatus 1.

The vibration device 5 is included inside the steering wheel, a seat, the accelerator, or the brake pedal of the target vehicle and outputs vibration. For example, the vibration device 5 includes a vibration speaker that outputs vibration and an amplifier that controls the magnitude of vibration output from the vibration speaker. The vibration speaker can change the frequency structure, the tempo, and the rhythm of vibration that is output, the magnitude of the vibration, and the position of the vibration under control by the driving assistance apparatus 1.

The projector device 6 is provided externally to the target vehicle and projects information on a road surface around the target vehicle. The projector device 6 can change the position, the color, the size, the timing, the luminance, and time for projecting information and the shape of an image under control by the driving assistance apparatus 1.

The vehicle control device 7 performs various types of control for implementing autonomous driving of the target vehicle. Examples of various types of control include lane keeping control, navigation control, and stop control. The vehicle control device 7 also predicts a point at which autonomous driving is switched to manual driving and sets this point as a scheduled switching point. The vehicle control device 7 notifies the driving assistance apparatus 1 of schedule information indicating that it is scheduled to switch from autonomous driving to manual driving a certain period of time before the target vehicle actually reaches the scheduled switching point.

Note that the point at which autonomous driving is switched to manual driving is a point at which manual driving is expected to be more appropriate than autonomous driving. Examples of a point at which autonomous driving is switched to manual driving include a point at which it is predicted that a course change is required a plurality of times along with branching or merging of roads, such as an interchange on an expressway.

The driving assistance apparatus 1 includes a determination processing unit 11 and a notification processing unit 12. The determination processing unit 11 determines whether or not a vehicle is present around the target vehicle on the basis of detection information around the target vehicle. For example, the determination processing unit 11 performs image analysis of image information around the target vehicle captured by an exterior camera and determines whether or not a vehicle is present around the target vehicle on the basis of the image analysis result. Alternatively, the determination processing unit 11 can also determine whether or not a vehicle is present around the target vehicle on the basis of a result of analyzing an object detected by the exterior sensor.

The notification processing unit 12 notifies information to a driver of the target vehicle. For example, the notification processing unit 12 notifies information by using at least one of the display device 3, the sound device 4, the vibration device 5, and the projector device 6. In addition, in a case where the determination processing unit 11 determines that there is no vehicle ahead of the target vehicle at the time of switching from autonomous driving to manual driving in the target vehicle, the notification processing unit 12 notifies reference information of manual driving. The reference information of manual driving indicates, for example, a speed and a traveling direction recommended to the target vehicle during manual driving.

For example, the notification processing unit 12 can control the display device 3 to display an arrow image indicating the traveling direction of the target vehicle. In addition, the notification processing unit 12 may control the sound device 4 to output, by voice, the speed limit of a road on which the target vehicle is traveling and may control the vibration device 5 to output vibration at a tempo corresponding to the speed of the target vehicle. Furthermore, the notification processing unit 12 may control the display device 3 to display image information simulating a vehicle traveling ahead of the target vehicle.

Next, the operation of the driving assistance apparatus 1 will be described.

FIG. 2 is a flowchart illustrating a driving assistance method according to the first embodiment and illustrating the operation of the driving assistance apparatus 1 of FIG. 1.

First, the notification processing unit 12 gives an advance notice of switching from autonomous driving to manual driving (step ST1). For example, after receiving, from the vehicle control device 7, schedule information indicating that it is scheduled to switch from autonomous driving to manual driving in the target vehicle, the notification processing unit 12 notifies announcement information of switching from autonomous driving to manual driving. The announcement information indicates that the target vehicle reaches the scheduled switching point and autonomous driving is switched to manual driving when a certain period of time (for example, about several minutes) elapses from the current time. The announcement information may be displayed on the display device 3 or may be output by sound using the sound device 4.

The determination processing unit 11 determines whether or not a vehicle is present ahead of the target vehicle (step ST2). For example, when it is notified from the vehicle control device 7 that it is scheduled to switch from autonomous driving to manual driving in the target vehicle, the determination processing unit 11 performs image analysis on image information ahead of the target vehicle captured by the exterior camera and determines whether or not a vehicle is present ahead of the target vehicle on the basis of the image analysis result. For the image analysis, for example, an image analysis method such as template matching is used. Alternatively, the determination processing unit 11 may determine whether or not a vehicle is present ahead of the target vehicle by analyzing an object detected by the exterior sensor.

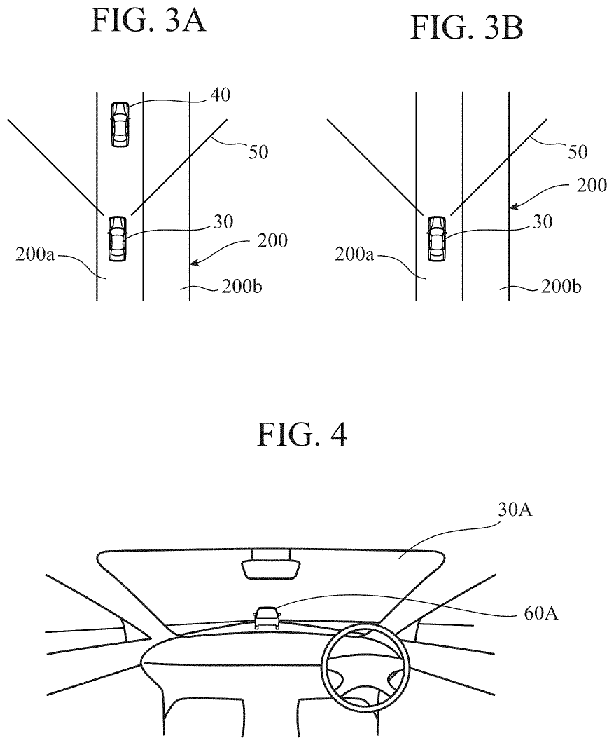

FIG. 3A is a diagram illustrating a case where a vehicle 40 is present ahead of a target vehicle 30, and FIG. 3B is a diagram illustrating a case where the vehicle 40 is not present ahead of the target vehicle 30. In FIGS. 3A and 3B, a road 200 is a two-lane road having a lane 200a on which the target vehicle 30 is traveling and an opposite lane 200b on which a vehicle traveling in a direction opposite to that of the target vehicle 30 is traveling. As illustrated in FIG. 3A, the vehicle 40 whose presence is determined by the determination processing unit 11 is traveling in the same direction as that of the target vehicle 30 and is included in a field of view 50 of the driver.

In the case where the vehicle 40 is present when autonomous driving is switched to manual driving in the target vehicle 30, the driver of the target vehicle 30 drives the target vehicle 30 so as to follow the travel of the vehicle 40, whereby autonomous driving is smoothly switched to manual driving, and furthermore, the driver can recognize the state of the road 200 (such as presence or absence of traffic congestion). That is, the vehicle 40 is a so-called reference vehicle that serves as a reference for manual driving for the driver of the target vehicle 30. Note that in a case where the target vehicle 30 is traveling on a road with two or more lanes on each side, a vehicle traveling on a lane different from that of the target vehicle 30 can also be a reference vehicle as long as the traveling direction is the same as that of the target vehicle 30.

As illustrated in FIG. 3B, in a case where the vehicle 40 is not present when autonomous driving is switched to manual driving, the driver of the target vehicle 30 easily makes an error in the driving operation such as sudden acceleration or deceleration since there is no reference vehicle. Therefore, the driving assistance apparatus 1 gives the driver an advance notice regarding the switching from autonomous driving to manual driving and then notifies the driver of reference information of manual driving before actually switching to manual driving. As a result, the driver can drive the target vehicle 30 in accordance with the reference information even when the vehicle 40 is not present.

If the determination processing unit 11 determines that the vehicle 40 is present ahead of the target vehicle 30 (step ST2; YES), the driver of the target vehicle 30 is only required to drive the vehicle 40 as a reference vehicle, and thus the process of FIG. 2 ends. On the other hand, if it is determined that the vehicle 40 is not present ahead of the target vehicle 30 (step ST2; NO), the determination processing unit 11 outputs the absence of a reference vehicle to the notification processing unit 12.

After receiving the notification from the determination processing unit 11, the notification processing unit 12 notifies the reference information to the driver (step ST3). For example, the notification processing unit 12 notifies reference information including a speed and a traveling direction recommended to the target vehicle 30 by manual driving using at least one of the display device 3, the sound device 4, the vibration device 5, and the projector device 6. Note that the speed recommended to the target vehicle 30 may be a legal maximum speed or a legal minimum speed of the road or may be a speed set in consideration of ecological driving.

The notification processing unit 12 may cause the display device 3 to display together the speed recommended to the target vehicle 30 by manual driving and the speed of the target vehicle 30 at the time when autonomous driving is switched to manual driving. The notification processing unit 12 may determine the traveling direction of the target vehicle 30 on the basis of detection information output from at least one of the steering angle sensor, the angular velocity sensor, the shift sensor, the blinker sensor, and the hazard sensor.

Meanwhile, the reference information may be image information simulating a vehicle traveling ahead of the target vehicle 30. FIG. 4 is a diagram illustrating display example 1 of image information 60A simulating a vehicle traveling ahead of the target vehicle 30 and illustrating image information 60A projected on a windshield 30A of the target vehicle 30 by the HUD. For example, the notification processing unit 12 generates the image information 60A of a preceding vehicle that appears to have a certain inter-vehicle distance from the target vehicle 30 using road information acquired from the navigation system, vehicle speed information of the target vehicle 30 acquired from the vehicle speed sensor, and position information of the target vehicle 30 acquired from the GPS device. Then, the notification processing unit 12 controls the HUD to project the image information 60A on the windshield 30A of the target vehicle 30. As a result, even when no reference vehicle is actually present, the driver can drive the target vehicle 30 so as to follow the preceding vehicle that is the image information 60A, thereby mitigating the error in the driving operation.

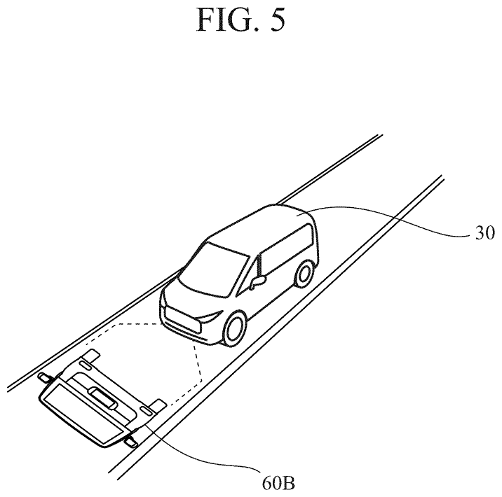

FIG. 5 is a diagram illustrating display example 2 of image information simulating a vehicle traveling ahead of the target vehicle 30 and illustrating image information 60B projected on a road surface ahead of the target vehicle 30 by the projector device 6. For example, the notification processing unit 12 generates the image information 60B of a preceding vehicle that appears to have a certain inter-vehicle distance from the target vehicle 30 using road information acquired from the navigation system, vehicle speed information of the target vehicle 30 acquired from the vehicle speed sensor, and position information of the target vehicle 30 acquired from the GPS device. Then, the notification processing unit 12 controls the projector device 6 to project the image information 60B on the road surface ahead of the target vehicle 30. As a result, even when no reference vehicle is actually present, the driver can drive the target vehicle 30 so as to follow the preceding vehicle that is the image information 60B, thereby mitigating the error in the driving operation. Note that the notification processing unit 12 may predict the brightness around the target vehicle 30 on the basis of output information of at least one of the wiper sensor, the light sensor, and the illuminance sensor and, in a case where it is predicted that the surroundings of the target vehicle 30 are dark, may notify the reference information using the projector device 6.

Next, a hardware configuration for implementing the functions of the driving assistance apparatus 1 according to the first embodiment will be described. The functions of the determination processing unit 11 and the notification processing unit 12 in the driving assistance apparatus 1 are implemented by a processing circuit. That is, the driving assistance apparatus 1 includes a processing circuit for executing the processes from step ST1 to step ST3 in FIG. 2. The processing circuit may be dedicated hardware or a central processing unit (CPU) for executing a program stored in a memory.

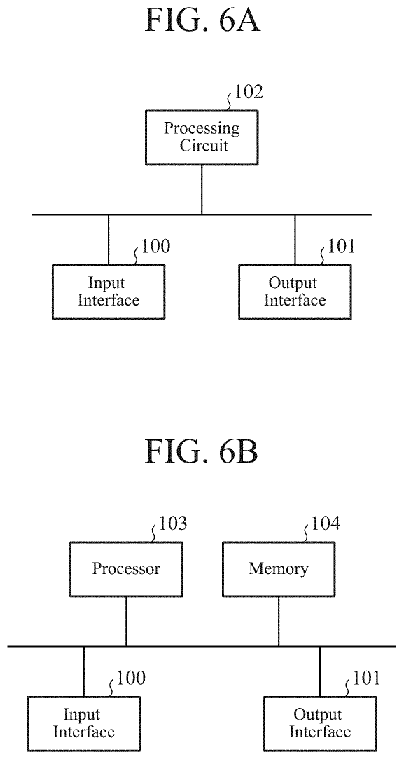

FIG. 6A is a block diagram illustrating a hardware configuration for implementing the functions of the driving assistance apparatus 1. FIG. 6B is a block diagram illustrating a hardware configuration for executing software for implementing the functions of the driving assistance apparatus 1. In FIGS. 6A and 6B, an input interface 100 relays, for example, detection information output from the group of sensors 2 to the driving assistance apparatus 1 or schedule information output from the vehicle control device 7 to the driving assistance apparatus 1. An output interface 101 relays control information of reference information and notifications output from the driving assistance apparatus 1 to the display device 3, the sound device 4, the vibration device 5, and the projector device 6.

In a case where the processing circuit is a processing circuit 102 of dedicated hardware illustrated in FIG. 6A, the processing circuit 102 corresponds to, for example, a single circuit, a composite circuit, a programmed processor, a parallel programmed processor, an application specific integrated circuit (ASIC), a field-programmable gate array (FPGA), or a combination thereof. The functions of the determination processing unit 11 and the notification processing unit 12 in the driving assistance apparatus 1 may be implemented by separate processing circuits, or these functions may be collectively implemented by a single processing circuit.

In a case where the processing circuit is a processor 103 illustrated in FIG. 6B, the functions of the determination processing unit 11 and the notification processing unit 12 in the driving assistance apparatus 1 are implemented by software, firmware, or a combination of software and firmware. Note that the software or the firmware is described as a program and is stored in a memory 104.

The processor 103 implements the functions of the determination processing unit 11 and the notification processing unit 12 in the driving assistance apparatus 1 by reading and executing a program stored in the memory 104. For example, the driving assistance apparatus 1 includes the memory 104 for storing programs that, when executed by the processor 103, result in execution of the processes of steps ST1 to ST3 in the flowchart illustrated in FIG. 2. These programs cause a computer to execute the procedures or methods performed by the determination processing unit 11 and the notification processing unit 12. The memory 104 may be a computer-readable storage medium storing the programs for causing a computer to function as the determination processing unit 11 and the notification processing unit 12.

The memory 104 corresponds to a nonvolatile or volatile semiconductor memory such as a random access memory (RAM), a read only memory (ROM), a flash memory, an erasable programmable read only memory (EPROM), or an electrically-EPROM (EEPROM), a magnetic disc, a flexible disc, an optical disc, a compact disc, a mini disc, a DVD, or the like.

Some of the functions of the determination processing unit 11 and the notification processing unit 12 in the driving assistance apparatus 1 may be implemented by dedicated hardware, and some of the functions may be implemented by software or firmware. For example, the functions of the determination processing unit 11 are implemented by the processing circuit 102 that is dedicated hardware, and the functions of the notification processing unit 12 are implemented by the processor 103 reading and executing programs stored in the memory 104. In this manner, the processing circuit can implement the functions described above by hardware, software, firmware, or a combination thereof.

As described above, in a case where it is determined that the vehicle 40 is not present ahead of the target vehicle 30, the driving assistance apparatus 1 according to the first embodiment notifies the driver of the target vehicle 30 of the reference information. Since the driver can drive the target vehicle 30 in accordance with the reference information even when the vehicle 40 is not present ahead of the target vehicle 30, it is possible to assist manual driving switched from autonomous driving when the vehicle 40 is not present ahead of the target vehicle 30.

### Second Embodiment

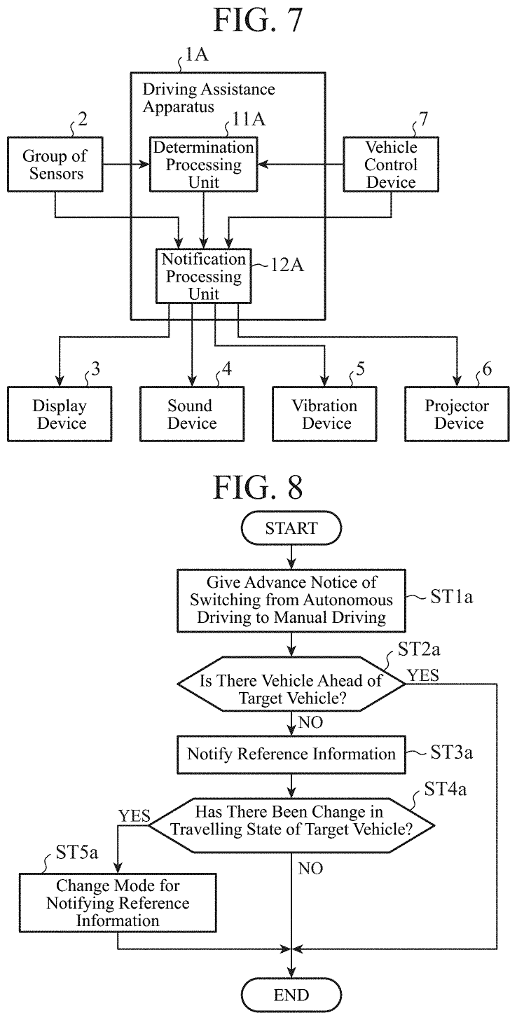

FIG. 7 is a block diagram illustrating the configuration of a driving assistance apparatus 1A according to a second embodiment. In FIG. 7, the same component as that in FIG. 1 is denoted by the same symbol, and description thereof is omitted. The driving assistance apparatus 1A is mounted on a target vehicle, for example, and assists switching from autonomous driving to manual driving in the target vehicle. The target vehicle is mounted with a group of sensors 2, a display device 3, a sound device 4, a vibration device 5, a projector device 6, and a vehicle control device 7. The driving assistance apparatus 1A also includes a determination processing unit 11A and a notification processing unit 12A.

The determination processing unit 11A operates similarly to the determination processing unit 11. In addition, the determination processing unit 11A determines whether or not there has been a change in the traveling state of the target vehicle when autonomous driving is switched to manual driving on the basis of detection information output from the group of sensors 2. Note that a change in the traveling state of the target vehicle refers to a change deviating from a traveling state recommended by the reference information and is, for example, a change in which the speed of the target vehicle becomes faster or slower than the speed recommended by the reference information.

The notification processing unit 12A operates similarly to the notification processing unit 12. In addition, the notification processing unit 12A changes the mode of notifying the reference information depending on the traveling state of the target vehicle after autonomous driving is switched to manual driving. The mode of notifying the reference information refers to, for example in a case where the reference information is image information, the size, the shape, the color, and the display position of image information displayed on the display device 3, and in a case where the reference information is sound information, the mode refers to the volume, the output timing, the tempo, and the rhythm output from the sound device 4. Furthermore, the notification processing unit 12A may change the output interval of vibration output from the vibration device 5 depending on the traveling state of the target vehicle.

Next, the operation of the driving assistance apparatus 1A will be described.

FIG. 8 is a flowchart illustrating a driving assistance method according to the second embodiment and illustrating the operation of the driving assistance apparatus 1A of FIG. 7. Note that processes of steps ST1a to ST3a are the same as those of steps ST1 to ST3 in FIG. 2, and thus description thereof is omitted. When reference information is notified by the notification processing unit 12A in step ST3a, the target vehicle is switched from autonomous driving to manual driving.

After autonomous driving is switched to manual driving in the target vehicle, the determination processing unit 11A determines whether or not there has been a change in the traveling state of the target vehicle (step ST4a). For example, the determination processing unit 11A determines whether or not there has been a change in the traveling state of the target vehicle on the basis of detection information of at least one of the vehicle speed sensor, the steering angle sensor, the accelerator sensor, the brake sensor, the acceleration sensor, and the angular velocity sensor of the group of sensors 2.

If the target vehicle maintains a traveling state recommended by the reference information and there has been no change in the traveling state (step ST4a; NO), the driver is only required to continue the driving operation as of that time, and thus the process of FIG. 8 ends. Note that while the target vehicle is manually driven, the flow may return to the process of step ST4a and repeat the above-described determination.

If the determination processing unit 11A determines that there has been a change in the traveling state of the target vehicle (step ST4a; YES), the notification processing unit 12A changes the mode of notifying the reference information depending on the traveling state of the target vehicle (step ST5a).

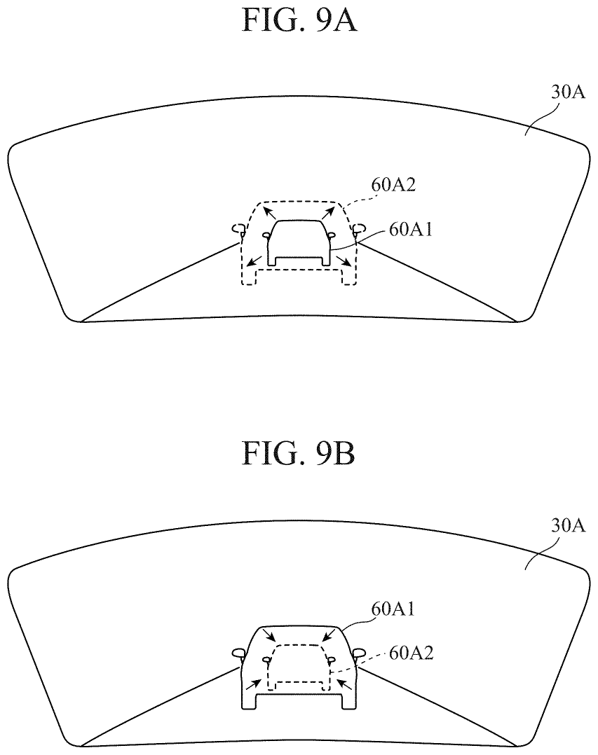

FIG. 9A is a diagram illustrating change example 1 of display of image information 60A1 and 60A2 simulating a vehicle traveling ahead of the target vehicle and illustrating the image information 60A1 and 60A2 projected on the windshield 30A of the target vehicle 30 by the HUD. The notification processing unit 12A displays the image information 60A1 on the HUD when the driver is driving the target vehicle at the speed recommended by the reference information.

In a case where the driver gradually increases the speed of the target vehicle to be faster than the speed recommended by the reference information, the notification processing unit 12A makes a gradual change toward the image information 60A2 having a larger size than that of the image information 60A1 as the speed of the target vehicle changes. When the driver visually recognizes the change from the image information 60A1 to the image information 60A2, the driver feels that the speed of the target vehicle is excessively increased and the inter-vehicle distance from the preceding vehicle is shortened, and thus the driver decelerates the target vehicle. As a result, the speed of the target vehicle returns to the speed recommended by the reference information.

FIG. 9B is a diagram illustrating change example 2 of display of image information simulating a vehicle traveling ahead of the target vehicle and illustrating the image information 60A1 and 60A2 projected on the windshield 30A of the target vehicle 30 by the HUD similarly to FIG. 9A. In FIG. 9B, the notification processing unit 12A displays image information 60A1 on the HUD when the driver is driving the target vehicle at the speed recommended by the reference information.

In a case where the driver gradually reduces the speed of the target vehicle to be slower than the speed recommended by the reference information, the notification processing unit 12A makes a gradual change toward the image information 60A2 having a smaller size than that of the image information 60A1 as the speed of the target vehicle changes. When the driver visually recognizes the change from the image information 60A1 to the image information 60A2, the driver feels that the speed of the target vehicle is excessively reduced and the inter-vehicle distance from the preceding vehicle is increased, and thus the driver accelerates the target vehicle. As a result, the speed of the target vehicle returns to the speed recommended by the reference information.

In a case where the driver gradually increases the speed of the target vehicle so as to be faster than the speed recommended by the reference information, the notification processing unit 12A may gradually shorten the output interval of vibration from the vibration device 5 depending on the change in the speed, and in a case where the driver gradually reduces the speed of the target vehicle so as to be slower than the speed recommended by the reference information, the notification processing unit 12A may gradually lengthen the output interval of vibration from the vibration device 5 depending on the change in the speed. The driver can recognize that the speed of the target vehicle deviates from the speed recommended by the reference information from the interval of vibration transmitted to the driver, and the driver drives the target vehicle so as to return to the speed recommended by the reference information.

Note that the functions of the determination processing unit 11A and the notification processing unit 12A in the driving assistance apparatus 1A are implemented by a processing circuit. That is, the driving assistance apparatus 1A includes a processing circuit for executing the processes from step ST1a to step ST5a illustrated in FIG. 8. The processing circuit may be the processing circuit 102 which is dedicated hardware illustrated in FIG. 6A or may be the processor 103 that executes a program stored in the memory 104 illustrated in FIG. 6B.

As described above, in the driving assistance apparatus 1A according to the second embodiment, the notification processing unit 12A changes the mode of notifying the reference information depending on the traveling state of the target vehicle. Since the driver can recognize whether or not the vehicle deviates from the traveling state recommended by the reference information from the change in the mode of notifying the reference information, the driver can return to the traveling state recommended by the reference information even when there is a deviation.

### Third Embodiment

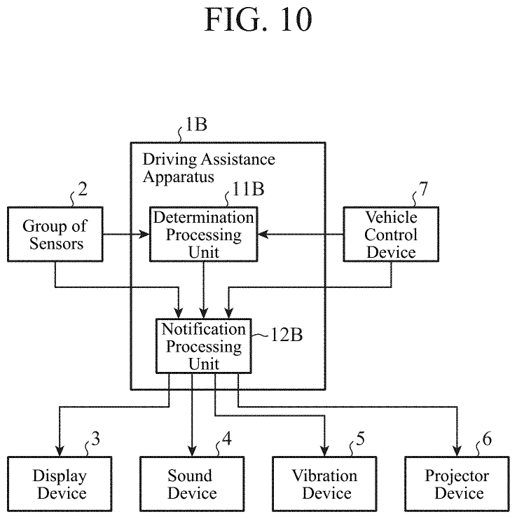

FIG. 10 is a block diagram illustrating the configuration of a driving assistance apparatus 1B according to a third embodiment. In FIG. 10, the same component as that in FIG. 1 is denoted with the same symbol, and description thereof is omitted. The driving assistance apparatus 1B is, for example, mounted on a target vehicle and assists switching from autonomous driving to manual driving in the target vehicle. The target vehicle is mounted with a group of sensors 2, a display device 3, a sound device 4, a vibration device 5, a projector device 6, and a vehicle control device 7. The driving assistance apparatus 1B includes a determination processing unit 11B and a notification processing unit 12B.

The determination processing unit 11B operates similarly to at least one of the determination processing unit 11 and the determination processing unit 11A. In addition, in a case where it is determined that a vehicle is present ahead of the target vehicle, the determination processing unit 11B determines whether or not the vehicle is a reference vehicle that serves as a reference for manual driving. For example, in a case where the vehicle present ahead of the target vehicle is (1) not stopped, (2) is traveling in the same direction as that of the target vehicle, and (3) is within the field of view of the driver without being excessively far from the position of the target vehicle, it is determined that the vehicle is a reference vehicle.

In addition, in a case where the determination processing unit 11B determines that there is a vehicle ahead of the target vehicle at the time of switching from autonomous driving to manual driving in the target vehicle, the notification processing unit 12B limits reference information to be notified. “To limit reference information” means to reduce the amount of information to be notified as reference information. For example, in a case where there is no vehicle ahead of the target vehicle, image information simulating a vehicle traveling ahead of the target vehicle as well as a speed and a traveling direction that are recommended are notified to the target vehicle, whereas in a case where there is a vehicle ahead of the target vehicle, notification of the image information using the display device 3 is not performed, and only audio notification of the speed and the traveling direction using the sound device 4 is performed.

In addition, similarly to the second embodiment, the notification processing unit 12B may change the mode of notifying the reference information depending on the traveling state of the target vehicle after autonomous driving is switched to manual driving in the target vehicle. Furthermore, in a case where the vehicle present ahead of the target vehicle is a reference vehicle, the notification processing unit 12B notifies information indicating a feature of this vehicle. The information indicating a feature of the vehicle is information indicating an appearance feature of the vehicle, and is, for example, a color or the type of the vehicle. The information indicating a feature of the vehicle also includes information such as a direction in which the vehicle is present when viewed from the target vehicle, a movement of the vehicle such as changing lanes, or a signal light.

Next, the operation of the driving assistance apparatus 1B will be described.

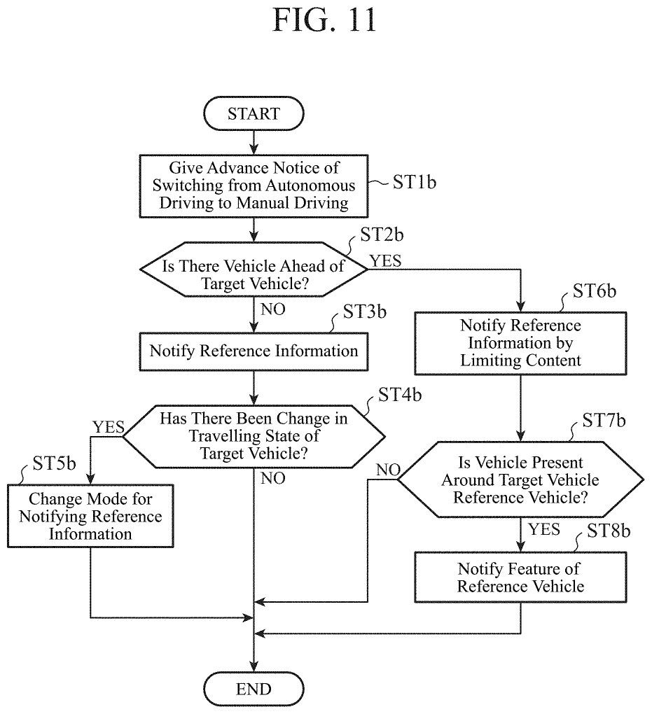

FIG. 11 is a flowchart illustrating a driving assistance method according to a third embodiment and illustrating the operation of the driving assistance apparatus 1B of FIG. 10. Processes of steps ST1b to ST5b are the same as those of steps STla to ST5a in FIG. 8, and thus description thereof is omitted.

If the determination processing unit 11B determines that there is a vehicle ahead of the target vehicle (step ST2b; YES), the notification processing unit 12B limits reference information and thereby notifies (step ST6b). In a case where there is a vehicle ahead of the target vehicle, there is a high possibility that this vehicle is a reference vehicle, and thus the amount of the reference information is reduced as compared with a case where there is no vehicle ahead of the target vehicle. As a result, unnecessary notification of the reference information is prevented. When the reference information is notified by the notification processing unit 12B, the target vehicle is switched from autonomous driving to manual driving.

Next, the determination processing unit 11B detects a traveling state of a vehicle present ahead of the target vehicle and determines whether or not the vehicle present ahead of the target vehicle is a reference vehicle on the basis of the traveling state that has been detected (step ST7b). For example, the determination processing unit 11B detects the traveling state of the vehicle present ahead of the target vehicle on the basis of image information ahead of the target vehicle captured by the exterior camera, detection information of the vehicle present ahead of the target vehicle detected by the exterior sensor, and the speed of the target vehicle detected by the vehicle speed sensor. The determination processing unit 11B determines that the vehicle is a reference vehicle in a case where the vehicle is not stopped, is traveling in the same direction as that of the target vehicle, and is within the field of view of the driver of the target vehicle on the basis of the traveling state of the vehicle.

If it is determined that the vehicle present ahead of the target vehicle is not a reference vehicle (step ST7b; NO), the process of FIG. 11 ends. Note that there is a possibility that the traveling state of the vehicle determined as not being a reference vehicle changes and satisfies the conditions of a reference vehicle, and thus the determination of step ST7b may be repeated while the target vehicle is manually driven.

If it is determined that the vehicle present ahead of an oncoming vehicle is a reference vehicle (step ST7b; YES), the determination processing unit 11B detects a feature of the reference vehicle and outputs information indicating a feature of the reference vehicle to the notification processing unit 12B. For example, the determination processing unit 11B performs image analysis on the image information of the reference vehicle captured by the exterior camera, detects the color and the type of the reference vehicle on the basis of the image analysis result, and further calculates in which direction the reference vehicle is positioned as viewed from the target vehicle. The determination processing unit 11B outputs information including the color, the vehicle type, and the direction of the reference vehicle to the notification processing unit 12B.

The notification processing unit 12B notifies the information indicating the feature of the reference vehicle acquired from the determination processing unit 11B (step ST8b). For example, similarly to the reference information, the notification processing unit 12B notifies the feature of the reference vehicle using at least one of the display device 3, the sound device 4, and the projector device 6. For example, sound notification of “please refer to the white kei car on the right front” may be performed using the sound device 4, or text information may be displayed using the display device 3 or the projector device 6. The driver can drive the target vehicle so as to follow the reference vehicle that has been notified.

Note that the functions of the determination processing unit 11B and the notification processing unit 12B in the driving assistance apparatus 1B are implemented by a processing circuit. That is, the driving assistance apparatus 1B includes a processing circuit for executing the processes from step ST1b to step ST8b illustrated in FIG. 11. The processing circuit may be the processing circuit 102 which is dedicated hardware illustrated in FIG. 6A or may be the processor 103 that executes a program stored in the memory 104 illustrated in FIG. 6B.

As described above, in the driving assistance apparatus 1B according to the third embodiment, in a case where the determination processing unit 11B determines that a vehicle is present ahead of the target vehicle when the target vehicle is switched from autonomous driving to manual driving, the notification processing unit 12B limits reference information to be notified. As a result, unnecessary notification of the reference information is prevented.

In the driving assistance apparatus 1B according to the third embodiment, the determination processing unit 11B determines whether or not a vehicle present ahead of the target vehicle is a reference vehicle. As a result, the driver can drive the target vehicle so as to follow the reference vehicle determined by the driving assistance apparatus 1B.

In the driving assistance apparatus 1B according to the third embodiment, the determination processing unit 11B detects a feature of a vehicle determined as a reference vehicle, and the notification processing unit 12B notifies information indicating a feature of the reference vehicle detected by the determination processing unit 11B. As a result, the driver can drive the target vehicle so as to follow the reference vehicle that has been notified.

### Fourth Embodiment

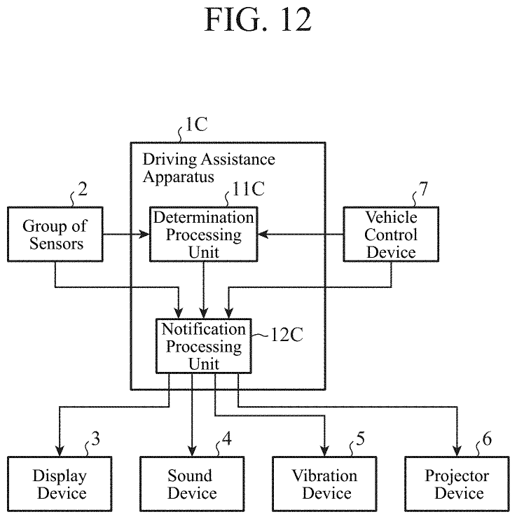

FIG. 12 is a block diagram illustrating the configuration of a driving assistance apparatus 1C according to a fourth embodiment. In FIG. 12, the same component as that in FIG. 1 is denoted with the same symbol, and description thereof is omitted. The driving assistance apparatus 1C is, for example, mounted on a target vehicle and assists switching from autonomous driving to manual driving in the target vehicle. The target vehicle is mounted with a group of sensors 2, a display device 3, a sound device 4, a vibration device 5, a projector device 6, and a vehicle control device 7. The driving assistance apparatus 1C includes a determination processing unit 11C and a notification processing unit 12C.

The determination processing unit 11C can operate similarly to at least one of the determination processing unit 11, the determination processing unit 11A, or the determination processing unit 11B. In addition, the determination processing unit 11C determines whether or not a vehicle is present ahead of, behind, or beside the target vehicle. For example, the determination processing unit 11C performs image analysis of image information around the target vehicle captured by the exterior camera and determines whether or not a vehicle is present ahead of, behind, or beside the target vehicle on the basis of the image analysis result. Even when it is determined that there is no vehicle ahead of the target vehicle when autonomous driving is switched to manual driving in the target vehicle, if it is determined that there is a vehicle behind or beside the target vehicle, the determination processing unit 11C outputs the determination result to the notification processing unit 12C.

The notification processing unit 12C can operate similarly to at least one of the notification processing unit 12, the notification processing unit 12A, or the notification processing unit 12B. In addition, when the determination processing unit 11C determines that there is no vehicle ahead of the target vehicle but there is a vehicle behind or beside the target vehicle at the time of switching autonomous driving to manual driving in the target vehicle, the notification processing unit 12C modifies the content of the reference information at the time of starting notification and notifies the reference information. For example, the notification processing unit 12C can assist manual driving of the driver so that the target vehicle has enough distance from a following vehicle or a side vehicle by changing the content of the reference information at the time of starting the notification.

Next, the operation of the driving assistance apparatus 1C will be described.

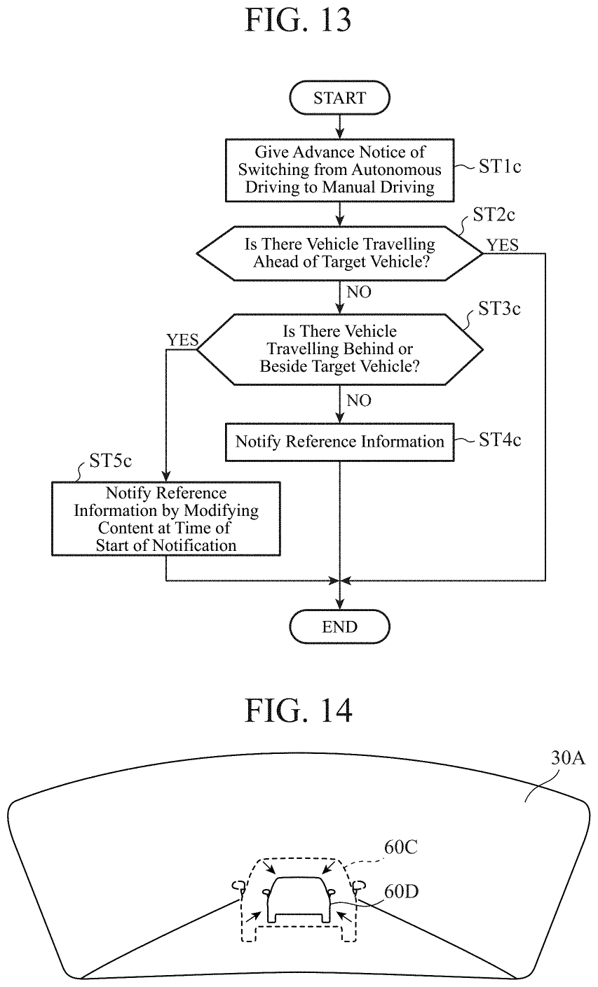

FIG. 13 is a flowchart illustrating a driving assistance method according to a fourth embodiment and illustrating the operation of the driving assistance apparatus 1C of FIG. 12. Processes of steps ST1c to ST2c are the same as those of steps ST1 to ST2 in FIG. 2, and thus description thereof is omitted. Note that if the determination processing unit 11C determines that a vehicle is present ahead of the target vehicle (step ST2c; YES), the processes of step ST6b to step ST8b in FIG. 11 may be executed.

If it is determined that there is no vehicle ahead of the target vehicle (step ST2c; NO), the determination processing unit 11C determines whether or not a vehicle is present behind or beside the target vehicle (step ST3c). For example, the determination processing unit 11C performs image analysis on image information behind the target vehicle captured by the exterior camera and determines whether or not a vehicle is present behind or beside the target vehicle on the basis of the image analysis result.

If it is determined that there is no vehicle behind or beside the target vehicle (step ST3c; NO), the determination processing unit 11C outputs to the notification processing unit 12C that there is no vehicle that can be a reference vehicle. After receiving the notification from the determination processing unit 11C, the notification processing unit 12C notifies the reference information in a similar procedure to the first embodiment (step ST4c). Then, the target vehicle is switched from autonomous driving to manual driving.

When it is determined that a vehicle is present behind or beside the target vehicle (step ST3c; YES), the determination processing unit 11C notifies the notification processing unit 12C that there is no vehicle ahead of the target vehicle but there is a vehicle behind or beside the target vehicle. After receiving the notification from the determination processing unit 11C, the notification processing unit 12C changes the content of the reference information at the time of starting the notification and thereby notifies the reference information (step ST5c). Then, the target vehicle is switched from autonomous driving to manual driving.

FIG. 14 is a diagram illustrating a change example of display of image information 60C and 60D simulating a vehicle traveling ahead of a target vehicle and illustrating the image information 60C and 60D projected on a windshield 30A of the target vehicle by an HUD. In step ST4c, the notification processing unit 12C generates the image information 60C of the preceding vehicle that appears to have a certain inter-vehicle distance from the target vehicle, and controls the HUD to project the image information 60C on the windshield 30A. When the driver visually recognizes the image information 60C, the driver feels that there is enough inter-vehicle distance from the preceding vehicle on the image indicated by the image information 60C, and thus it is possible to prevent sudden deceleration by the driver.

On the other hand, in a case where there is no vehicle ahead of the target vehicle, but for example there is a vehicle behind, the notification processing unit 12C controls the HUD to project, on the windshield 30A, the image information 60D smaller in size than the image information 60C or to project the image information 60C and then immediately project the image information 60D instead of the image information 60C. When the driver visually recognizes the image information 60D or visually recognizes the transition from the image information 60C to the image information 60D, the driver feels that the inter-vehicle distance between the target vehicle and the preceding vehicle has increased and thus accelerates the target vehicle. As a result, the distance between the target vehicle and the following vehicle is maintained.

Note that the functions of the determination processing unit 11C and the notification processing unit 12C in the driving assistance apparatus 1C are implemented by a processing circuit. That is, the driving assistance apparatus 1C includes a processing circuit for executing the processes of step ST1c to step ST5c illustrated in FIG. 13. The processing circuit may be the processing circuit 102 which is dedicated hardware illustrated in FIG. 6A or may be the processor 103 that executes a program stored in the memory 104 illustrated in FIG. 6B.

As described above, in the driving assistance apparatus 1C according to the fourth embodiment, when the determination processing unit 11C determines that there is no vehicle ahead of the target vehicle but there is a vehicle behind or beside the target vehicle at the time of switching autonomous driving to manual driving in the target vehicle, the notification processing unit 12C modifies the content of the reference information at the time of starting notification and notifies the reference information. As a result, the distance between the target vehicle and the following vehicle or the side vehicle is maintained at the timing when autonomous driving is switched to manual driving, and thus it is possible to avoid collision between the target vehicle and the following vehicle or the side vehicle even if driving operation is slightly erroneous in manual driving.

### Fifth Embodiment

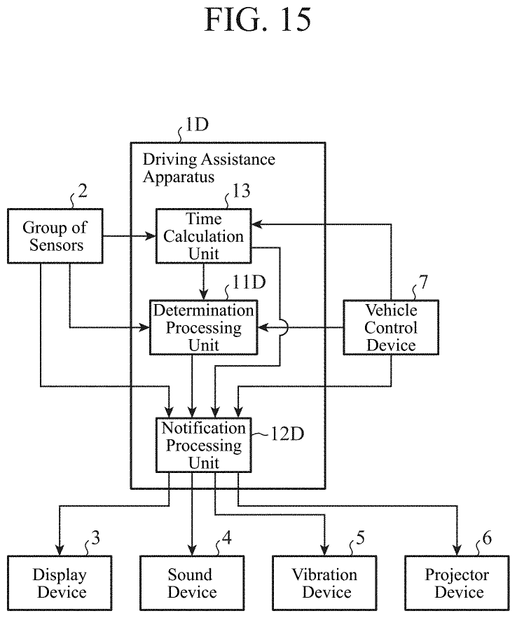

FIG. 15 is a block diagram illustrating the configuration of a driving assistance apparatus 1D according to a fifth embodiment. In FIG. 15, the same component as that in FIG. 1 is denoted with the same symbol, and description thereof is omitted. The driving assistance apparatus 1D is, for example, mounted on a target vehicle and assists switching from autonomous driving to manual driving in the target vehicle. The target vehicle is mounted with a group of sensors 2, a display device 3, a sound device 4, a vibration device 5, a projector device 6, and a vehicle control device 7. The driving assistance apparatus 1D includes a determination processing unit 11D, a notification processing unit 12D, and a time calculation unit 13.

The determination processing unit 11D operates similarly to at least one of the determination processing unit 11, the determination processing unit 11A, the determination processing unit 11B, or the determination processing unit 11C. In addition, the determination processing unit 11D determines whether or not a preceding vehicle of the target vehicle moves out of the driver's field of view within the switching time calculated by the time calculation unit 13. For example, the determination processing unit 11D determines the traveling direction of the target vehicle within the switching time on the basis of information indicating the traveling direction of the preceding vehicle acquired by the inter-vehicle communication with the preceding vehicle and information indicating the traveling direction of the target vehicle acquired from a navigation system. In a case where the preceding vehicle travels straight and the target vehicle turns right or left within the switching time, the determination processing unit 11D determines that the preceding vehicle moves out of the driver's field of view within the switching time.

The notification processing unit 12D operates similarly to at least one of the notification processing unit 12, the notification processing unit 12A, the notification processing unit 12B, or the notification processing unit 12C. Furthermore, when the determination processing unit 11D determines that the preceding vehicle moves out of the driver's field of view within the switching time, the notification processing unit 12D notifies image information simulating the preceding vehicle before the switching time elapses. For example, the notification processing unit 12D controls the display device 3 or the projector device 6 to display image information simulating the preceding vehicle. As a result, even when there is no preceding vehicle during manual driving, the driver can drive the target vehicle so as to follow the vehicle simulated by the image information.

The time calculation unit 13 calculates switching time required for switching from autonomous driving to manual driving in the target vehicle. For example, image analysis is performed on image information of the driver captured by an in-vehicle camera, the state of the driver is detected on the basis of the image analysis result, and switching time corresponding to the state of the driver is calculated by referring to table information. In the table information, the state of the driver and switching time corresponding thereto are set. The table information is obtained by, for example, performing an experiment of switching from autonomous driving to manual driving and statistically analyzing the result of the experiment.

For example, in a case where the driver is facing forward when switching from autonomous driving to manual driving is notified in advance, the driver can immediately drive the target vehicle, and the switching from autonomous driving to manual driving is performed in a short time. Therefore, switching time of about one to three seconds is set in the table information. On the other hand, in a case where the driver is facing obliquely downward or sideways, or faces downward or to a side, the driver needs to recognize the situation ahead of the vehicle before switching to manual driving. Therefore, since it takes more time to switch from autonomous driving to manual driving than in a case where the driver is facing forward (intermediate time), switching time of about several ten seconds is set in the table information. Furthermore, in a case where the driver is lying on the back when switching from autonomous driving to manual driving is notified in advance, there is a possibility that the driver is about to fall asleep. In this case, the driver needs to recognize the situation ahead of the vehicle after awakening to a state in which manual driving is possible and facing forward from the vehicle (long time), and thus switching time of about several minutes is set in the table information. Note that in a case where the switching time is long, there is a possibility that the switching cannot be performed even after passing a scheduled switching point that has been notified from the vehicle control device 7.

Next, the operation of the driving assistance apparatus 1D will be described.

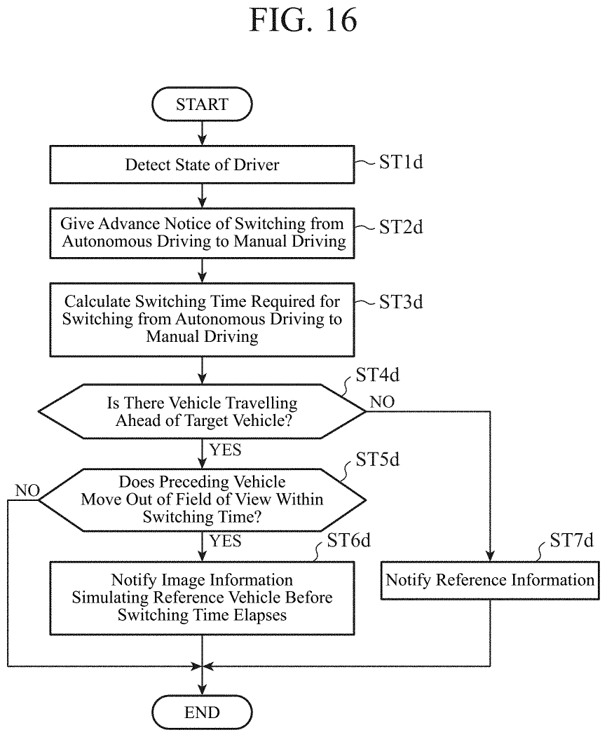

FIG. 16 is a flowchart illustrating a driving assistance method according to a fifth embodiment and illustrating the operation of the driving assistance apparatus 1D of FIG. 15.

First, the time calculation unit 13 detects the state of the driver of the target vehicle (step ST1d). For example, the time calculation unit 13 constantly detects the state of the driver from image information of the driver captured by the in-vehicle camera.

The notification processing unit 12D gives an advance notice of switching from autonomous driving to manual driving to the driver (step ST2d). For example, after receiving the switching schedule information from the vehicle control device 7, the notification processing unit 12D outputs announcement information on the basis of the schedule information. The announcement information may be, for example, displayed on the display device 3 or may be output by sound using the sound device 4.

The time calculation unit 13 calculates switching time required for switching from autonomous driving to manual driving (step ST3d). For example, the time calculation unit 13 detects the state of the driver at the timing when the schedule information is received from the vehicle control device 7 and calculates switching time corresponding to the state of the driver by referring to the table information. The switching time calculated by the time calculation unit 13 is output to the determination processing unit 11D and the notification processing unit 12D.

The determination processing unit 11D determines whether or not a vehicle is present around the target vehicle on the basis of detection information ahead of the target vehicle (step ST4d). Here, if it is determined that a vehicle is present ahead of the target vehicle (step ST4d; YES), the determination processing unit 11D determines whether or not the vehicle (reference vehicle) present ahead of the target vehicle moves out of the driver's field of view within the switching time calculated by the time calculation unit 13 (step ST5d).

If it is determined that the reference vehicle does not move out of the driver's field of view (step ST5d; NO), the driver of the target vehicle is only required to drive so as to follow the reference vehicle, and thus the process of FIG. 16 ends. At this point, the processes of steps ST3a to ST5a of FIG. 8 may be performed without ending the process of FIG. 16.

If it is determined that the reference vehicle moves out of the driver's field of view within the switching time (step ST5d; YES), the determination processing unit 11D outputs this determination result to the notification processing unit 12D. After receiving the notification from the determination processing unit 11D, the notification processing unit 12D notifies the driver of the image information simulating the reference vehicle before the switching time elapses (step ST6d). For example, the notification processing unit 12D controls the display device 3 or the projector device 6 to display the image information simulating the reference vehicle.

If it is determined that no vehicle is present ahead of the target vehicle (step ST4d; NO), the determination processing unit 11D outputs the determination result of the absence of a reference vehicle to the notification processing unit 12D. After receiving the notification from the determination processing unit 11D, the notification processing unit 12D notifies reference information of manual driving (step ST7d). For example, the reference information may be information indicating a speed and a traveling direction desirable for the target vehicle by manual driving or may be image information simulating a vehicle traveling ahead of the target vehicle.

Note that the functions of the determination processing unit 11D, the notification processing unit 12D, and the time calculation unit 13 in the driving assistance apparatus 1D are implemented by a processing circuit. That is, the driving assistance apparatus 1D includes a processing circuit for executing the processes of step ST1d to step ST7d illustrated in FIG. 16. The processing circuit may be the processing circuit 102 which is dedicated hardware illustrated in FIG. 6A or may be the processor 103 that executes a program stored in the memory 104 illustrated in FIG. 6B.

As described above, in the driving assistance apparatus 1D according to the fifth embodiment, the determination processing unit 11D determines whether or not the vehicle present ahead of the target vehicle moves out of the driver's field of view within the switching time required for switching from autonomous driving to manual driving. When the determination processing unit 11D determines that the preceding vehicle of the target vehicle moves out of the driver's field of view within the switching time, the notification processing unit 12D notifies image information simulating a reference vehicle before the switching time elapses. As a result, even when a reference vehicle disappears during manual driving, the driver can drive the target vehicle so as to follow an image of a reference vehicle.

### Sixth Embodiment

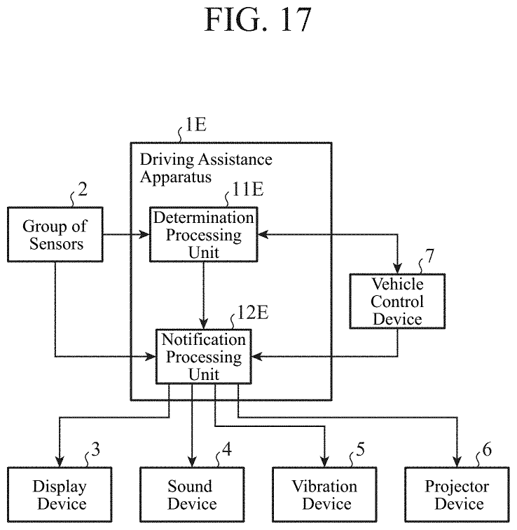

FIG. 17 is a block diagram illustrating the configuration of a driving assistance apparatus 1E according to a sixth embodiment. In FIG. 17, the same component as that in FIG. 1 is denoted with the same symbol, and description thereof is omitted. The driving assistance apparatus 1E is, for example, mounted on a target vehicle and assists switching from autonomous driving to manual driving in the target vehicle. The target vehicle is mounted with a group of sensors 2, a display device 3, a sound device 4, a vibration device 5, a projector device 6, and a vehicle control device 7. The driving assistance apparatus 1E includes a determination processing unit 11E and a notification processing unit 12E.

The determination processing unit 11E operates similarly to at least one of the determination processing unit 11, the determination processing unit 11A, the determination processing unit 11B, the determination processing unit 11C, or the determination processing unit 11D. In addition, the determination processing unit 11E instructs the vehicle control device 7 to control traveling of the target vehicle so as to travel while maintaining a distance within an allowable range from a vehicle present behind or beside the target vehicle (a following vehicle or a vehicle on a side). A distance within an allowable range refers to a distance at which collision between the target vehicle and the following vehicle or the vehicle on the side can be avoided even in a case where the speed of the target vehicle is reduced to be lower than the speed recommended in the reference information. Furthermore, in a case where it is determined that there is a following vehicle or a vehicle on a side before autonomous driving is switched to manual driving, the determination processing unit 11E can instruct the vehicle control device 7 to control the travel of the target vehicle so that the following vehicle or the vehicle on the side comes ahead of the target vehicle.

Next, the operation of the driving assistance apparatus 1E will be described.

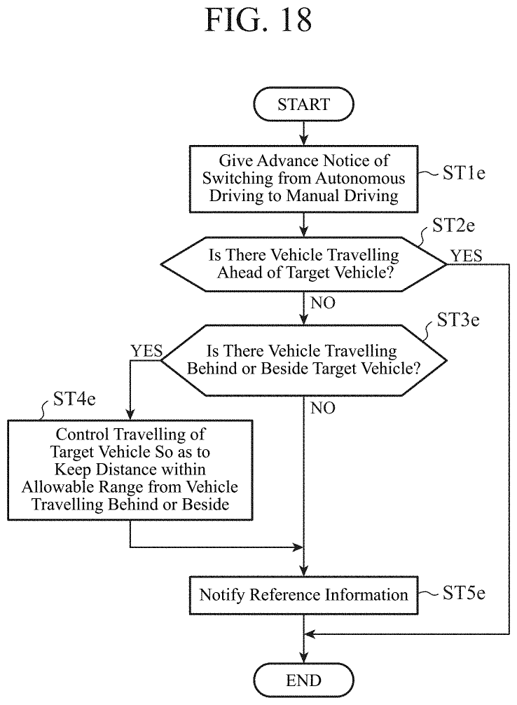

FIG. 18 is a flowchart illustrating a driving assistance method according to the sixth embodiment and illustrating the operation of the driving assistance apparatus 1E of FIG. 17. Processes of steps ST1e to ST2e are the same as those of steps ST1 to ST2 in FIG. 2, and thus description thereof is omitted. If the determination processing unit 11E determines that a vehicle is present ahead of the target vehicle (step ST2e; YES), the processes of step ST6b to step ST8b in FIG. 11 may be executed.

If it is determined that there is no vehicle ahead of the target vehicle (step ST2e; NO), the determination processing unit 11E determines whether or not a vehicle is present behind or beside the target vehicle (step ST3e). For example, the determination processing unit 11E performs image analysis on image information behind or beside the target vehicle captured by the exterior camera and determines whether or not a vehicle is present behind or beside the target vehicle on the basis of the image analysis result.

If it is determined that there is a vehicle behind or beside (step ST3e; YES), the determination processing unit 11E instructs the vehicle control device 7 to control the traveling of the target vehicle so as to maintain a distance within an allowable range from the vehicle behind or beside (step ST4e). As a result, since the target vehicle is kept at a distance within an allowable range from the vehicle behind or beside, for example, even if the driver reduces the speed of the target vehicle to be lower than the speed recommended by the reference information, a collision between the target vehicle and the vehicle behind is avoided.

If it is determined that there is no vehicle behind or beside (step ST3e; NO), the determination processing unit 11E outputs to the notification processing unit 12E that there is no vehicle that can be a reference vehicle. After receiving the notification from the determination processing unit 11E, the notification processing unit 12E notifies the reference information in a similar procedure to that of the first embodiment (step ST5e). Then, the target vehicle is switched from autonomous driving to manual driving.

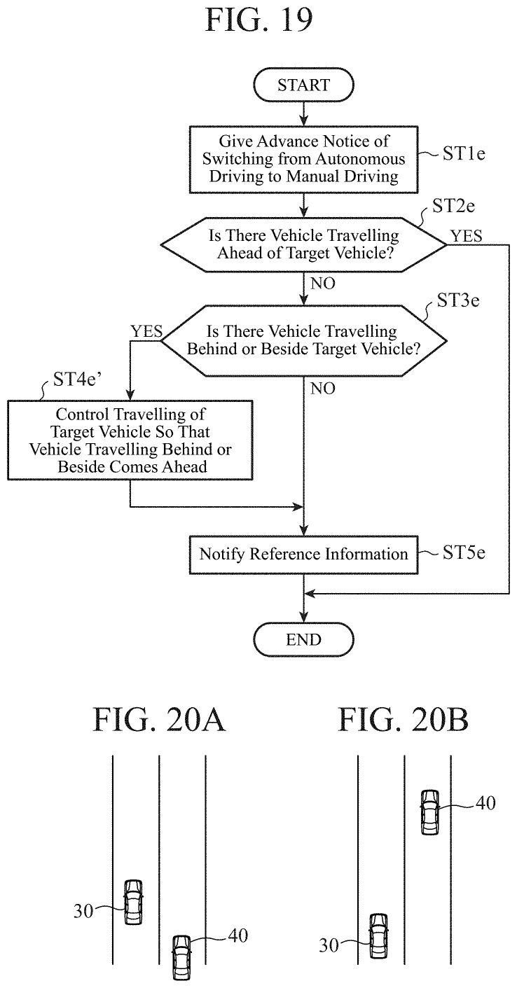

In addition, instead of the process of step ST4e, the process of step ST4e′ illustrated in FIG. 19 may be executed. If it is determined that a vehicle is present behind or beside (step ST3e; YES), the determination processing unit 11E instructs the vehicle control device 7 to control the travel of the target vehicle so that the vehicle behind or on the side comes ahead (step ST4e′). Note that, in the flowcharts of FIGS. 18 and 19, a case where step ST5e for notifying the reference information is performed after the process of step ST4e or step ST4e′ is executed is illustrated; however, without being limited thereto, the reference information is not necessarily need to be notified (step ST5e) after the process of step ST4e or step ST4e′ is executed, and the process can be terminated as it is.

FIG. 20A is a diagram illustrating the target vehicle 30 and a following vehicle 40, and FIG. 20B is a diagram illustrating a case where traveling of the target vehicle 30 is controlled so that the following vehicle 40 comes ahead. In the situation illustrated in FIG. 20A, it is assumed that both the target vehicle 30 and the following vehicle 40 are traveling at 90 kilometers per hour. In this case, the determination processing unit 11E determines that there is no vehicle traveling ahead of the target vehicle 30 but the following vehicle 40 is present.

In the situation illustrated in FIG. 20A, the determination processing unit 11E instructs the vehicle control device 7 and thereby adjusts the speed of the target vehicle 30 (decelerate, e.g. 80 kilometers per hour), changes the lanes as necessary, and causes the following vehicle 40 to travel ahead of the target vehicle 30 as illustrated in FIG. 20B. As a result, even if the driver reduces the speed of the target vehicle 30 to be lower than the speed recommended by the reference information, a collision between the target vehicle 30 and the following vehicle 40 is avoided.

Note that the functions of the determination processing unit 11E and the notification processing unit 12E in the driving assistance apparatus 1E are implemented by a processing circuit. That is, the driving assistance apparatus 1E includes a processing circuit for executing the processes from step STle to step ST5e illustrated in FIG. 18 (including step ST4e′ illustrated in FIG. 19). The processing circuit may be the processing circuit 102 which is dedicated hardware illustrated in FIG. 6A or may be the processor 103 that executes a program stored in the memory 104 illustrated in FIG. 6B.

As described above, in the driving assistance apparatus 1E according to the sixth embodiment, in a case where there is no vehicle ahead of the target vehicle 30 but there is, for example, a following vehicle 40 when the target vehicle 30 is switched from autonomous driving to manual driving, the determination processing unit 11E controls the travel of the target vehicle 30 so as to travel while maintaining a distance within an allowable range from the following vehicle 40 or controls the travel of the target vehicle 30 so that the following vehicle 40 comes ahead. As a result, even if the driver reduces the speed of the target vehicle 30, it is possible to avoid a collision between the target vehicle 30 and the following vehicle 40.

### Seventh Embodiment

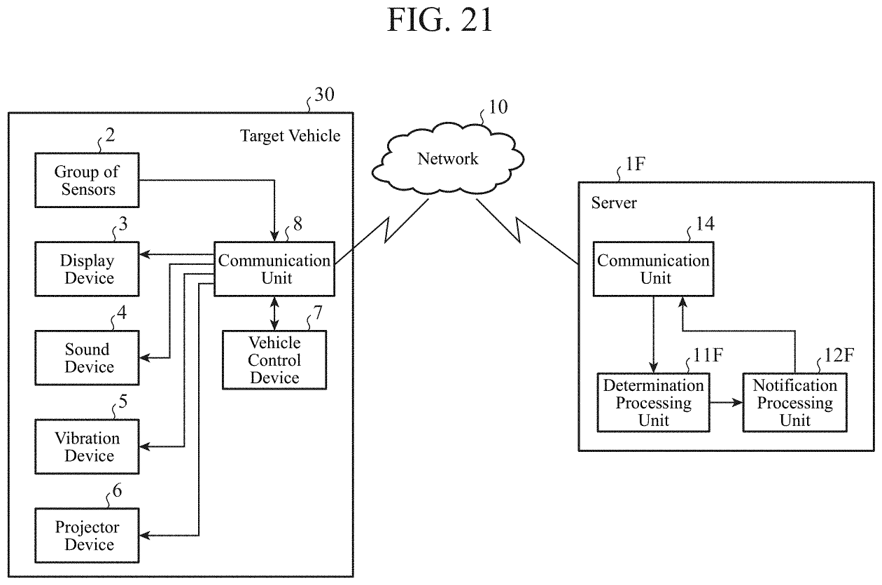

FIG. 21 is a block diagram illustrating a configuration example of a driving assistance system according to a seventh embodiment. In FIG. 21, the same component as that in FIG. 1 is denoted by the same symbol, and description thereof is omitted. In the driving assistance system illustrated in FIG. 21, a server 1F and a target vehicle 30 can communicate with each other via a network 10. The server 1F is a driving assistance apparatus that assists switching from autonomous driving to manual driving in the target vehicle 30 by controlling the target vehicle 30 by wireless communication via the network 10.

The server 1F includes a determination processing unit 11F, a notification processing unit 12F, and a communication unit 14. The target vehicle 30 includes a group of sensors 2, a display device 3, a sound device 4, a vibration device 5, a projector device 6, a vehicle control device 7, and a communication unit 8. The group of sensors 2 includes the various sensors described in the first embodiment and detects the surroundings of the target vehicle 30. The group of sensors 2 also includes a sensor that detects the state of the driver. The display device 3, the sound device 4, the vibration device 5, and the projector device 6 are output devices included in the target vehicle 30, and information is notified to the driver by at least one of these devices.

The communication unit 8 is provided in the target vehicle 30 and communicates with the communication unit 14 of the server 1F via the network 10. Meanwhile, the communication unit 14 is provided in the server 1F and communicates with the communication unit 8 of the target vehicle 30 via the network 10. For example, the communication unit 8 and the communication unit 14 perform wireless communication of transmitting information via an antenna and receiving information via the antenna.

The determination processing unit 11F determines whether or not a vehicle is present around the target vehicle 30 on the basis of detection information around the target vehicle 30. For example, the communication unit 14 receives, from the target vehicle 30, image information around the target vehicle 30 captured by the exterior camera of the group of sensors 2. The determination processing unit 11F performs image analysis on the image information received by the communication unit 14 and determines whether or not there is a vehicle around the target vehicle 30 on the basis of the image analysis result.

In addition, the determination processing unit 11F determines whether or not there has been a change in the traveling state of the target vehicle 30 on the basis of the detection information of the group of sensors 2 received by the communication unit 14 after autonomous driving is switched to manual driving. Furthermore, in a case where it is determined that a vehicle is present ahead of the target vehicle 30 on the basis of detection information of the group of sensors 2 received by the communication unit 14, the determination processing unit 11F can detect the traveling state of the vehicle. Like in the third embodiment, the determination processing unit 11F can determine whether or not the vehicle present ahead of the target vehicle 30 is a reference vehicle serving as a reference for manual driving on the basis of the traveling state that has been detected and can detect a feature of the reference vehicle.

When the determination processing unit 11F determines that there is no vehicle ahead of the target vehicle 30 at the time of switching from autonomous driving to manual driving in the target vehicle 30, the notification processing unit 12F notifies the driver of the target vehicle 30 of reference information as a reference for manual driving. For example, the notification processing unit 12F can notify the reference information to at least one of the display device 3, the sound device 4, the vibration device 5, and the projector device 6 by transmitting the reference information to the target vehicle 30 using the communication unit 14. Furthermore, in a case where it is determined that a vehicle is present ahead of the target vehicle 30, the notification processing unit 12F can limit reference information to be notified, as in the third embodiment.

In addition, the notification processing unit 12F can change the mode of notifying the reference information transmitted to the target vehicle 30 after autonomous driving is switched to manual driving depending on the traveling state of the target vehicle 30 determined by the determination processing unit 11F. For example, the notification processing unit 12F transmits reference information including notification control information for controlling a notification mode to the target vehicle 30 using the communication unit 14. With at least one of the display device 3, the sound device 4, the vibration device 5, and the projector device 6 notifying the reference information in accordance with the notification control information received by the communication unit 8, the mode of notifying the reference information is changed depending on the traveling state of the target vehicle 30. In a case where the determination processing unit 11F determines that a vehicle is present behind or beside the target vehicle 30, the notification processing unit 12F can also notify the reference information by using the notification control information by modifying the content of the reference information at the time of start of the notification.

In addition, the server 1F may include the time calculation unit 13 described in the fifth embodiment. For example, the time calculation unit 13 detects the state of the driver of the target vehicle 30 using detection information of the group of sensors 2 received by the communication unit 14 and calculates switching time by referring to table information in which the state of the driver and switching time corresponding thereto are set. Furthermore, the determination processing unit 11F can determine whether or not a preceding vehicle (reference vehicle) of the target vehicle 30 moves out of the driver's field of view by using the detection information of the group of sensors 2 received by the communication unit 14. In a case where the reference vehicle moves out of the driver's field of view within the switching time, the notification processing unit 12F transmits image information simulating the reference vehicle to the target vehicle 30 using the communication unit 14 to notify the driver of the image information before the switching time elapses.

Furthermore, the determination processing unit 11F can instruct the vehicle control device 7 using the communication unit 14 and thereby control the travel of the target vehicle 30 so as to travel while maintaining a distance within an allowable range from the vehicle behind or beside the target vehicle 30. In addition, the determination processing unit 11F may instruct the vehicle control device 7 using the communication unit 14 and thereby control the travel of the target vehicle 30 so that the vehicle behind or beside comes ahead of the target vehicle 30.

Although the server 1F functioning as the driving assistance apparatus has been described so far, a device caused to function as the driving assistance apparatus is not limited to the server 1F as long as the device can communicate with the communication unit 8 of the target vehicle 30. For example, a portable terminal brought into the target vehicle 30 such as a tablet device or a smartphone may be caused to function as the driving assistance apparatus.

As described above, in the driving assistance system according to the seventh embodiment, the determination processing unit 11F determines whether or not there is a vehicle around the target vehicle 30 on the basis of detection information around the target vehicle 30 received from the target vehicle 30 by the communication unit 14. If the determination processing unit 11F determines that there is no vehicle ahead of the target vehicle 30 at the time of switching from autonomous driving to manual driving in the target vehicle 30, the notification processing unit 12F transmits the reference information to the target vehicle 30 using the communication unit 14 and notifies the target vehicle 30 of the reference information. As a result, it is possible to assist manual driving switched from autonomous driving.

Note that the present invention is not limited to the above embodiments, and the present invention can include a flexible combination of the individual embodiments, a modification of any component of the individual embodiments, or omission of any component in the individual embodiments within the scope of the present invention.

### INDUSTRIAL APPLICABILITY

The driving assistance apparatus according to the present invention can be used in a vehicle having an autonomous driving function.

### REFERENCE SIGNS LIST

1, 1A to 1E: driving assistance apparatus, 1F: server, 2: group of sensors, 3: display device, 4: sound device, 5: vibration device, 6: projector device, 7: vehicle control device, 8, 14: communication unit, 10: network, 11, 11A to 11F: determination processing unit, 12, 12A to 12F: notification processing unit, 13: time calculation unit, 30: target vehicle, 30A: windshield, 40: vehicle, 50: field of view, 60A, 60A1, 60A2, 60B to 60D: image information, 100: input interface, 101: output interface, 102: processing circuit, 103: processor, 104: memory, 200: road, 200a: lane, 200b: opposite lane

1. A driving assistance apparatus comprising:
processing circuitry configured to
determine whether or not a vehicle is present around a target vehicle on a basis of detection information around the target vehicle; and
notify information to a driver of the target vehicle,
wherein the processing circuitry notifies the reference information of manual driving in a case where the processing circuitry determines that there is no vehicle ahead of the target vehicle when automatic driving is switched to manual driving in the target vehicle and before and after the switching.

2. The driving assistance apparatus according to claim 1,
wherein the reference information indicates a speed and a traveling direction recommended to the target vehicle for manual driving.

3. The driving assistance apparatus according to claim 1,
wherein the reference information is image information simulating a vehicle traveling ahead of the target vehicle.

4. The driving assistance apparatus according to claim 1,
wherein the processing circuitry determines whether or not a vehicle is present within a predetermined distance ahead of the target vehicle.

5. The driving assistance apparatus according to claim 1,
wherein the processing circuitry changes a mode of notifying the reference information depending on a traveling state of the target vehicle.

6. The driving assistance apparatus according to claim 1
wherein the processing circuitry limits the reference information to be notified in a case where the processing circuitry determines that there is a vehicle ahead of the target vehicle when autonomous driving is switched to manual driving in the target vehicle.

7. The driving assistance apparatus according to claim 1,
wherein the processing circuitry determines whether or not a vehicle traveling ahead of the target vehicle is a reference vehicle of manual driving.

8. The driving assistance apparatus according to claim 7,
wherein the processing circuitry detects a feature of the vehicle determined as the reference vehicle, and
the processing circuitry notifies a feature of the detected vehicle.

9. The driving assistance apparatus according to claim 1,
wherein the processing circuitry notifies the reference information by modifying content of the reference information at a time of starting notification in a case where the processing circuitry determines that there is no vehicle ahead of the target vehicle but there is a vehicle behind or beside the target vehicle when autonomous driving is switched to manual driving in the target vehicle.

10. The driving assistance apparatus according to claim 1, wherein the processing circuitry is further configured to
calculate a switching time required for switching from autonomous driving to manual driving,
wherein the processing circuitry determines whether or not a vehicle traveling ahead of the target vehicle moves out of a field of view of the driver of the target vehicle within the switching time, and
in a case where the processing circuitry determines that the vehicle traveling ahead of the target vehicle moves out of the field of view of the driver within the switching time, the processing circuitry notifies image information simulating the vehicle traveling ahead of the target vehicle before the switching time elapses.

11. The driving assistance apparatus according to claim 1,
wherein, in a case where the processing circuitry determines that there is no vehicle ahead of the target vehicle but there is a vehicle behind or beside the target vehicle when autonomous driving is switched to manual driving in the target vehicle, the processing circuitry controls traveling of the target vehicle so as to travel while maintaining a distance within an allowable range from the vehicle traveling behind or beside or controls traveling of the target vehicle so that the vehicle traveling behind or beside comes ahead of the target vehicle.

12. A driving assistance system comprising:
a group of sensors to detect surroundings of a target vehicle;
an output device included in the target vehicle;
processing circuitry configured to
determine whether or not a vehicle is present around the target vehicle on a basis of detection information around the target vehicle detected by the group of sensors; and
notify information to a driver of the target vehicle using the output device,
wherein the processing circuitry notifies reference information of manual driving in a case where the processing circuitry determines that there is no vehicle ahead of the target vehicle when automatic driving is switched to manual driving in the target vehicle and before and after the switching.

13. A driving assistance method of a driving assistance apparatus comprising processing circuitry, comprising:
determining whether or not a vehicle is present around a target vehicle on a basis of detection information around the target vehicle;
notifying information to a driver of the target vehicle; and
notifying reference information of manual driving in a case where it is determined that there is no vehicle ahead of the target vehicle when automatic driving is switched to manual driving in the target vehicle and before and after the switching.
